(19) United States
(12) Patent Application Publication
(10) Pub. No.: US 2007/0026793 A1
(43) Pub. Date: Feb. 1, 2007

(54) Method and system for audio repeating among portable communication devices

(75) Inventor: Jorge L. Perdomo, Boca Raton, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/194,726

(22) Filed: Aug. 1, 2005

(51) Int. Cl. H04B 1/60; H04B 7/15

(52) U.S. Cl. 455/11.1; 455/10

(57) ABSTRACT

An audio repeater mode method (100) uses a primary wireless device (12) and at least one secondary wireless device (14 and 16) among a plurality of secondary devices (14, 16, 17, and 18) to selectively choose and control (102) one or more secondary wireless devices. The primary device measures (106) an ambient noise level and optionally captures speech from a user to provide a preferred hearing level. The ambient noise level can be measured (108) at secondary devices and compared with the preferred hearing level. Optionally, a relative distance can be measured (110) from the primary device to the secondary device(s). An indication of the ambient noise level and the audio signal is transmitted (112) by the primary device which causes (114) an adjustment of an audio output level at a selected secondary device based on measured ambient noise levels, the preferred hearing level, and the relative distance measured.

### FIELD OF THE INVENTION

This invention relates generally to audio repeaters, and more particularly to a method and system for improving wireless communication devices serving as audio repeaters.

### BACKGROUND OF THE INVENTION

A typical public address system that audibly addresses a group of people in an room or a large environment can be made obsolete with the use of today's cellular phone technology to a certain extent. Existing phones can dynamically form themselves into a group and repeat an audible signal. Unfortunately, such systems are not optimized as to the selection of repeaters or for ambient noise or for distances between the audible speech and the potential immediate listeners of such audible speech created by a main or primary speaker. In many instances, such system will over compensate with a high audio output and create distortion that fails to simulate the primary speaker's original speech.

### SUMMARY OF THE INVENTION

Embodiments in accordance with the present invention can provide a communication system and method using a plurality of wireless devices including a primary wireless device and a plurality of secondary wireless devices that can operate together to serve as an intercom or public address system. The primary wireless device can acquire the audio speech and transmit a corresponding signal to selected secondary wireless devices that can recreate the audio speech subject to adjustments based on one or more factors including the ambient noise level at the primary wireless device, a preferred hearing level determined at the primary wireless device, an ambient noise level at the respective (selected) secondary wireless devices, or the respective relative distance(s) from the primary wireless device to the selected secondary wireless device.

In a first embodiment of the present invention, a method of operating in an audio repeater mode a plurality of wireless communication devices including a primary wireless device and at least one secondary wireless device among a plurality of secondary wireless devices can include the steps of acquiring an audio signal at the primary wireless device, measuring an ambient noise level in an environment of the primary wireless device, and selectively choosing and controlling at least one secondary wireless device by the primary wireless device during the audio repeater mode. The method can further include the steps of transmitting (via networked or non-networked communication links) an indication of the ambient noise level and the audio signal to the at least one secondary wireless, and causing an adjustment of an audio output level at a selected secondary wireless device among the at least one secondary wireless device based on the indication of the ambient noise level from the primary wireless device. The method can further include the step of measuring the relative distance from the primary wireless device to the at least one secondary wireless device. Note, the repeater mode in the primary wireless device can be enabled by a user of the primary wireless device, a request from a user of a secondary wireless device, or possibly by a base station or carrier in communication with the primary wireless device. A security code such as a password can be used to enable or disable the audio repeater mode.

Operationally, the method can further include the steps of capturing speech from a primary user at the primary wireless device to provide a preferred hearing level above the ambient noise level and the step of measuring the ambient noise level at the at least one secondary wireless device and comparing it to the to the preferred hearing level. The method can use a measured relative distance from the primary wireless device to the at least one secondary wireless device and configuring the audio output level based on the ambient noise level at the secondary wireless device, the preferred hearing level, and the relative distance.

In a second embodiment of the present invention, a method of operating in an audio repeater mode a plurality of wireless communication devices including a primary wireless device and a selected group of secondary wireless devices in communication with the primary wireless device among a plurality of secondary wireless devices can include the steps of acquiring an audio signal at the primary wireless device, measuring the relative distances from the primary wireless device to the selected group of secondary wireless devices, transmitting the audio signal to the selected group of secondary wireless devices, and causing an adjustment of an audio output level at the selected group of secondary wireless devices based on the relative distance measured between the primary wireless device and each of the secondary wireless devices among the selected group. The method can further include the step of measuring an ambient noise level in an environment of the primary wireless device and transmitting (via a networked or non-networked communication link) an indication of the ambient noise level to the selected group of secondary wireless devices. Note, the selected group of secondary wireless devices can be selectively chosen and controlled by the primary device during the audio repeater mode.

The method can further include the steps of capturing speech from a primary user at the primary wireless device to provide a preferred hearing level above the ambient noise level at the primary wireless device, measuring the ambient noise level at the selected group of secondary wireless devices and comparing ambient noise level at each of the selected secondary wireless devices to the preferred hearing level. The method can further include individually adjusting an audio output at the selected group of secondary wireless devices based on available combinations among measurements of the ambient noise level at the primary and the selected group of secondary wireless devices, the preferred hearing level, and the relative distance from the primary wireless device to each of the respective secondary wireless devices.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of an communication system operating in a audio repeater mode in accordance with an embodiment of the present invention.

FIG. 2 is an illustration of another communication system operating in an audio repeater mode in accordance with an embodiment of the present invention.

FIG. 3 is a dynamic list of wireless communication devices including corresponding distance measurements and ambient noise measurements for devices shown in FIG. 2 in accordance with an embodiment of the present invention.

FIG. 4 is a flow chart illustrating a method of operating in an audio repeater mode a plurality of wireless communication devices in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

A high quality intercom system or ad hoc public address system can be created from existing wireless devices modified to behave and interact to acquire an audible input at a primary wireless device and to transmit a signal to recreate an audible output at selected secondary wireless devices. Such a system can resolve a problem found in an everyday environment where an individual needs to speak to a group of individuals in a large or loud environment where individuals might not hear the speaker properly due to noise or other factors.

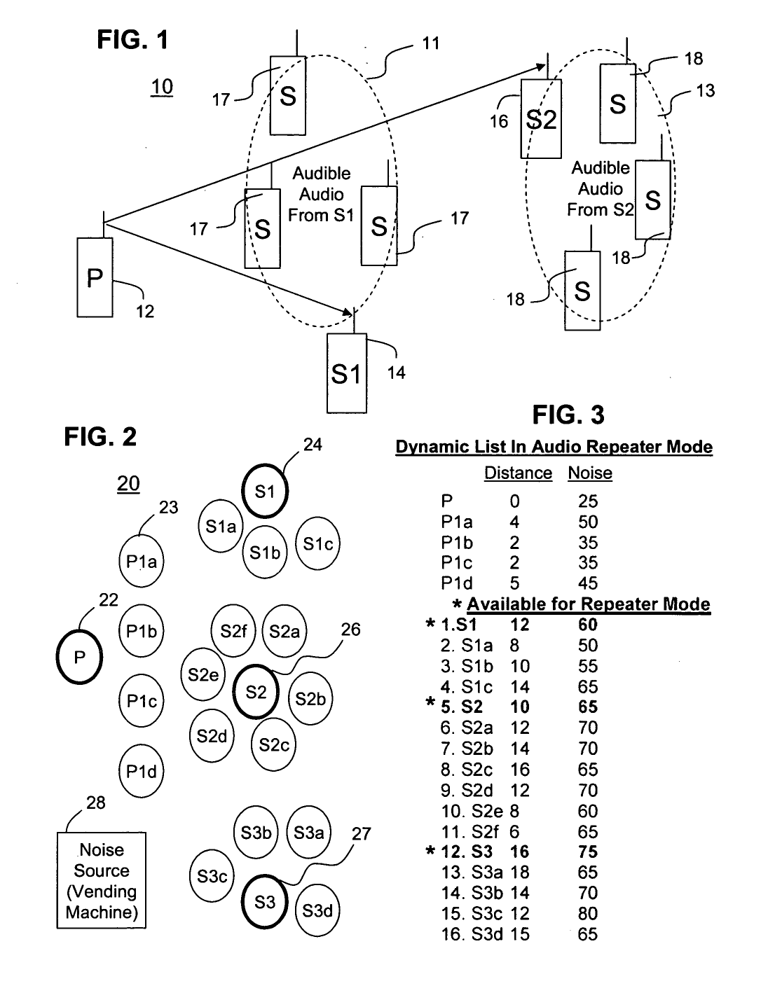

Referring to the communication system 10 of FIG. 1, a primary wireless device 12 can operate as the acquirer of the audio speech input and transmitter to a selected plurality of secondary devices 14 and 16 among a plurality of secondary wireless devices (14, 16, 17, and 18). In the particular configuration shown, secondary wireless devices 17 are within an audible range 11 of selected secondary wireless device 14 whereas secondary wireless devices 18 are within an audible range 13 of selected secondary wireless device 16. How secondary wireless devices 14 and 16 are selected can vary based on numerous factors including measured ambient noise at the selected secondary wireless device, relative distances from the primary wireless device to the selected secondary wireless device or to a group of secondary wireless devices, location information (e.g., GPS information) obtained for primary and secondary wireless devices, or by a specific request by a secondary wireless device.

The primary wireless device 12 can be enabled in an intercom or audio repeater mode by a user or can be remotely enabled by a user of one of the secondary wireless devices by a request. In yet another alternative, the audio repeater mode can be initiated by a carrier or a third party requesting the carrier to have the primary wireless device enter the audio repeater mode. The primary wireless device 12 can measure the ambient noise and optionally or alternatively measure the relative distances from the primary wireless device to available devices in the room or surroundings among the plurality of secondary wireless devices. The distance determinations can be achieved by using short-range RF wireless technology or GPS location information or a combination of both. Use of GPS information alone in this context might be more effective in larger outdoor environments to provide relative distance measurements, but also might be effective in smaller environments where increased GPS accuracy is available. In order to transmit the speech from the primary wireless device to the selected secondary wireless devices, the primary wireless device can either use a network based transport such as a cellular network or a non-network based transport such as Bluetooth or 802.11. In the event that the plurality of secondary wireless devices include a mix of transports the primary wireless device can transmit in both network and non-networked based communication links if needed.

Referring to FIG. 2, another communication system 20 is shown containing a plurality of wireless devices including a primary wireless device 22, a plurality of secondary wireless devices 23 (P1a-P1d) within audible range of the primary wireless device 22, a first group (S1, S1a, S1b, S1c) of secondary wireless devices within audible range of a selected secondary wireless device 24, a second group (S2, S2a-S2e) of secondary wireless devices within audible range of a selected secondary wireless device 26, and a third group (S3, S3a-S3d) of secondary wireless devices within audible range of a selected secondary wireless device 27. Also within the environment of the communication system 20 is a noise source 28 such as a vending machine that is closest to the third group of secondary wireless devices and the selected secondary wireless device 27.

Referring to FIG. 3, the plurality of wireless devices in FIG. 2 can be placed in a dynamic list. The wireless devices can be mapped into the primary wireless device 22 and organized relative to ambient noise or distance or both. A predetermined set of secondary wireless devices (S1 or 24, S2 or 26, S3 or 27) can be enabled to play high audio based on one or more factors including appropriate permissions, measured ambient noise levels, preferred audio listening level, and measured relative distances. Only the selected secondary devices (24, 26, 27) will be enabled to play audio at a satisfactory level for surrounding individuals to hear the speech properly. In most instances, a secondary wireless device that is subject to less ambient noise than other secondary wireless devices within a particular group can be selected, but such a choice might not be available or determined as the best choice based on permissions or other factors such as relative distance to other members in a particular group. For example, although selected secondary wireless device 27 does not have the lowest measured ambient noise level, it was likely chosen due to its relative distance to other members in its group (S3a-d) and its availability to serve in the audio repeater mode.

As discussed above, the primary wireless device can measure the ambient noise and/or relative distances from the primary wireless device to available devices in the room or surroundings. In one embodiment, these measurements can be performed by existing cellular vocoder functions. The primary wireless device can measure ambient noise level and assign a threshold value which can be transmitted to all secondary wireless devices. The primary speaker can speak into the primary wireless device to capture a level above ambient noise and will calculate a delta or difference value from the threshold to the speaker voice level. The audible repeater mode can have a predefined or definable preferred hearing level that might match or correlate with the delta value determined. The secondary devices will measure their ambient noise levels to capture a threshold and compare it to the preferred hearing level. Once the noise level and preferred hearing level delta are calculated, the system can optionally determine the layout of the secondary devices in a given area. The distance can be achieved by using short-range RF wireless technology. Thus, the preferred hearing level can be achieved or relatively balanced within each audible listening range (see 11 and 13 in FIG. 1).

An assumption can be made that the secondary wireless devices are stationary and subject to the same ambient noise levels initially measured. An enhancement can include a periodic calibration based on new measurements for distance or ambient noise levels or both. If the primary is moving then a predefined distance option can be determined or selected by the primary device in order to maintain control of the group. The creation of the dynamic list can be similar to a Selective Dynamic Group Call (SDGC) available on some iDEN communication networks by Motorola, Inc. of Schaumburg, Ill.

Once the speech input at the primary wireless device is complete, the primary wireless device can disable the audible repeater mode and the list can be deleted. In the event a secondary wireless device is no longer available due to distance or excessive ambient noise, or the device exits from the audible repeater mode, the primary wireless device can seek an alternate device substantially equivalent to the non-available device.

Note, in order to allow the primary wireless device full audio control over the secondary wireless devices, the primary wireless device can send a password to allow the secondary devices to disable repeater mode. In such a scenario, the user of the secondary wireless device can disable the repeater mode by entering the password or pin to exit the mode. Another embodiment can allow the secondary wireless device to authenticate transmissions using biometric information from the primary that can be validated prior to the meeting or searching a data base in order to ensure that the primary source is secured and tamper proof.

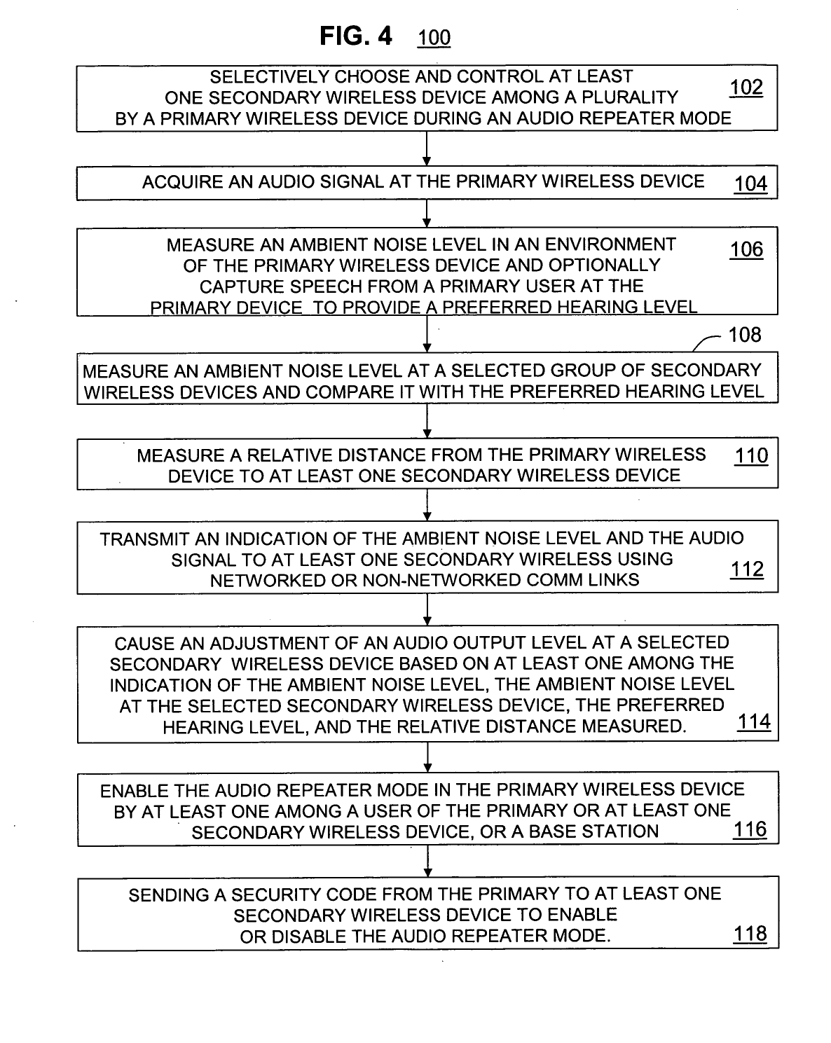

Referring to FIG. 4, a flow chart illustrating a method 100 of operating in an audio repeater mode a plurality of wireless communication devices including a primary wireless device and at least one secondary wireless device among a plurality of secondary wireless devices is shown. The method 100 can include the step 102 of selectively choosing and controlling at least one secondary wireless device among a plurality of secondary wireless devices by a primary wireless device during an audio repeater mode and acquiring at step 104 an audio signal at the primary wireless device. At step 106, the method 100 can measure an ambient noise level in an environment of the primary wireless device and optionally capture speech from a primary user at the primary wireless device to provide a preferred hearing level above the ambient noise level. At step 108, an ambient noise level can be measured at a selected group of secondary wireless devices and compared with the preferred hearing level.

Optionally, the method 100 can further include the step 110 of measuring a relative distance from the primary wireless device to the at least one secondary wireless device. At step 112, an indication of the ambient noise level and the audio signal can be transmitted to the at least one secondary wireless using networked or carrier based communication links or non-networked or non-carrier based communication links. The primary wireless device can cause an adjustment of an audio output level at a selected secondary wireless device among the group of secondary wireless devices based on at least one among the indication of the ambient noise level from the primary wireless device, the ambient noise level at the selected secondary wireless device, the preferred hearing level, and the relative distance measured at step 114. The audio repeater mode in the primary wireless device can be enabled at step 116 by at least one among a user of the primary wireless device, a user of at least one secondary wireless device, and a base station in communication with the primary wireless device. Another option can include the step 118 of sending a security code from the primary wireless device to at least one secondary wireless device to enable or disable the audio repeater mode.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of operating in an audio repeater mode a plurality of wireless communication devices including a primary wireless device and at least one secondary wireless device among a plurality of secondary wireless devices, comprising the steps of:
acquiring an audio signal at the primary wireless device;
measuring an ambient noise level in an environment of the primary wireless device;
selectively choosing and controlling the at least one secondary wireless device by the primary wireless device during the audio repeater mode;
transmitting an indication of the ambient noise level and the audio signal to the at least one secondary wireless; and
causing an adjustment of an audio output level at a selected secondary wireless device among the at least one secondary wireless device based on the indication of the ambient noise level from the primary wireless device.

2. The method of claim 1, wherein the method further comprises the step of measuring the relative distance from the primary wireless device to the at least one secondary wireless device.

3. The method of claim 1, wherein the method further comprises the step of enabling the audio repeater mode in the primary wireless device by a user of the primary wireless device, a user of at least one secondary wireless device, or a base station in communication with the primary wireless device.

4. The method of claim 1, wherein the method further comprises the step of sending a security code from the primary wireless device to the at least one secondary wireless device to enable or disable the audio repeater mode.

5. The method of claim 1, wherein the method further comprises the step of capturing speech from a primary user at the primary wireless device to provide a preferred hearing level above the ambient noise level at the primary wireless device.

6. The method of claim 5, wherein the method further comprises the step of measuring the ambient noise level at the at least one secondary wireless device and comparing it to the preferred hearing level.

7. The method of claim 6, wherein the method further comprises the step of measuring a relative distance from the primary wireless device to the at least one secondary wireless device and configuring the audio output level based on the ambient noise level at the secondary wireless device, the preferred hearing level, and the relative distance.

8. The method of claim 1, wherein the step of transmitting the indication of the ambient noise level and the audio signal to the at least one secondary wireless device is done by a networked-based communication link or a non-networked-based communication link.

9. A method of operating in an audio repeater mode a plurality of wireless communication devices including a primary wireless device and a selected group of secondary wireless devices in communication with the primary wireless device among a plurality of secondary wireless devices, comprising the steps of:
acquiring an audio signal at the primary wireless device;
measuring the relative distances from the primary wireless device to the selected group of secondary wireless devices;
transmitting the audio signal to the selected group of secondary wireless devices; and
causing an adjustment of an audio output level at the selected group of secondary wireless devices based on the relative distance measured between the primary wireless device and each of the secondary wireless devices among the selected group.

10. The method of claim 9, wherein the method further comprises the step of measuring an ambient noise level in an environment of the primary wireless device and transmitting an indication of the ambient noise level to the selected group of secondary wireless devices.

11. The method of claim 9, wherein the method further comprises the step of selectively choosing and controlling the selected group of secondary wireless devices by the primary wireless device during the audio repeater mode.

12. The method of claim 9, wherein the method further comprise the step of enabling the audio repeater mode in the primary wireless device by a user of the primary wireless device, a user of the selected group of secondary wireless devices, or a base station in communication with the primary wireless device.

13. The method of claim 9, wherein the method further comprises the step of sending a security code from the primary wireless device to the selected group of secondary wireless devices to enable or disable the audio repeater mode.

14. The method of claim 9, wherein the method further comprises the step of capturing speech from a primary user at the primary wireless device to provide a preferred hearing level above the ambient noise level at the primary wireless device.

15. The method of claim 14, wherein the method further comprises the step of measuring the ambient noise level at the selected group of secondary wireless devices and comparing it to the preferred hearing level.

16. The method of claim 14, wherein the method further comprises the step of measuring the ambient noise level at the selected group of secondary wireless devices, comparing it to the to the preferred hearing level, and individually adjusting an audio output at the selected group of secondary wireless devices based on available combinations among measurements of the ambient noise level at the primary wireless device and the selected group of secondary wireless devices, the preferred hearing level, or the relative distance from the primary wireless device to the respective secondary wireless device among the selected group of secondary wireless devices.

17. The method of claim 10, wherein the step of transmitting the indication of the ambient noise level and the audio signal to the selected group of secondary wireless devices is done a networked-based communication link or a non-networked-based communication link.

18. A machine-readable storage, having stored thereon a computer program having a plurality of code sections executable by a machine for causing the machine to perform the steps of:
acquiring an audio signal at the machine serving as a primary wireless device;
measuring the relative distances from the primary wireless device to a selected group of secondary wireless devices in communication with the primary wireless device;
transmitting the audio signal to the selected group of secondary wireless devices; and
causing an adjustment of an audio output level at the selected group of secondary wireless devices based on the relative distance measured between the primary wireless device and each of the secondary wireless devices among the selected group.

19. The machine readable storage of claim 18, wherein the computer program further comprises a plurality of code sections for causing the machine to measure an ambient noise level in an environment of the primary wireless device and transmit an indication of the ambient noise level to the selected group of secondary wireless devices.

20. The machine readable storage of claim 18, wherein the computer program further comprises a plurality of code sections for causing the machine to capture speech from a primary user at the primary wireless device to provide a preferred hearing level above the ambient noise level at the primary wireless device, measure the ambient noise level at the selected group of secondary wireless devices, compare it to the to the preferred hearing level, and individually adjust an audio output at the selected group of secondary wireless devices based on measurements of the ambient noise level at the primary and the selected group of secondary wireless devices, the preferred hearing level, and the relative distance from the primary wireless device to the respective secondary wireless devices among the selected group of secondary wireless devices.
